(19) United States
(12) Patent Application Publication
(10) Pub. No.: US 2022/0263557 A1
(43) Pub. Date: Aug. 18, 2022

(54) A METHOD OF REPORTING CHANNEL STATE INFORMATION, A COMMUNICATION SYSTEM, AND A METHOD OF SCHEDULING TCI

(71) Applicant: NEC Corporation, Minato-ku, Tokyo (JP)

(72) Inventors: Venkatarao GONUGUNTLA, Tokyo (JP); Hisashi FUTAKI, Tokyo (JP); Tetsu IKEDA, Tokyo (JP); Sadafuku HAYASHI, Tokyo (JP)

(73) Assignee: NEC Corporation, Minato-ku, Tokyo (JP)

(21) Appl. No.: 17/628,984

(22) PCT Filed: Jun. 18, 2020
(86) PCT No.: PCT/JP2020/023934

§ 371 Date: Jan. 21, 2022

(30) Foreign Application Priority Data
Aug. 14, 2019 (IN) 201911032978

(51) Int. Cl. H04B 7/06; H04W 24/08

(52) U.S. Cl. CPC H04B 7/0626; H04W 24/08; H04B 7/0695

(57) ABSTRACT

This present disclosure provides a mechanism to classify CSI report(s) into valid/partially valid/invalid CSI report(s) by defining a new CSI evaluation methodology. The present disclosure also introduces a new UE behaviour of sending different (valid/partially valid/invalid) type of CSI report to inform the gNB about the TCI state known status at the UE. The present disclosure also introduces an implicit or explicit signalling method to inform the type of CSI report to the gNB. The present disclosure also discloses new UE behaviour of skipping CSI reports between partially valid/invalid CSI report and valid CSI report during TCI state switching/SCell activation.

### TECHNICAL FIELD

This disclosure is related to a method of reporting channel state information, a communication system, and a method of scheduling TCI.

### BACKGROUND ART

NR uses directional beam forming technique to transmit towards a specific direction. Multiple beams are transmitted from gNB to cover the entire area of a cell. UE receiver antenna spatial filter direction has to be tuned to proper direction as shown in FIG. 1 to receive beam at peak signal strength. When UE moves from one beam coverage to other beam coverage, UE has to switch from one beam to other beam or adjust its spatial reception direction. For seamless switch from one beam to another beam, UE has to track and report multiple beams to gNB.

To facilitate beam tracking, reporting and switching between beams, each beam is associated with a Transmission Configuration Indication (TCI) state. gNB indicates TCI states to UE through RRC signalling. Each TCI state is associated with a reference signal such as SSB and/or CSI-RS. In other words, indication of a TCI state for PDSCH and/or PDCCH transmission implies informing the device that a certain PDSCH and/or PDCCH is transmitted using the same spatial filter as the configured reference signal such as SSB/CSI-RS.

CORESET (NPL 1) is a set of physical resources (a specific area on NR Downlink Resource Grid) and a set of parameters that is used to carry PDCCH/DCI. In short it is equivalent to LTE PDCCH area.

UE can be configured with up to 64 candidate PDCCH TCI states. By using MAC CE (NPL 2), network can dynamically indicate UE to switch to a specific TCI state, within the per-CORESET (NPL 1)-configured subset. When monitoring for PDCCH within a certain CORESET, the UE can assume that the PDCCH transmission uses the same spatial filter as the reference signal associated with the indicated TCI by means of MAC CE. In other words, if the device has earlier determined a suitable receiver-side beam direction for reception of the reference signal, the device can assume that the same beam direction is suitable for reception of the PDCCH (NPL 3).

A device can be configured with up to 128 candidate TCI states. For PDSCH beam indication, there are two methods defined depending on the scheduling offset. That is, depending on the transmission timing of the PDSCH relative to the corresponding PDCCH carrying scheduling information for the PDSCH. If this scheduling offset is larger than N symbols, the DCI of the scheduling assignment may explicitly indicate the TCI state for the PDSCH transmission. To enable this, the device is first configured with a set of up to eight TCI states from the originally configured set of candidate TCI states, which can be called as active TCI states. A three-bit indicator within the DCI then indicates the exact TCI state valid for the scheduled PDSCH transmission. If the scheduling offset is smaller or equal to N symbols, the device should instead assume that the PDSCH transmission is QCL with the corresponding PDCCH transmission (NPL 3).

In short, TCI state switch for PDCCH is triggered using MAC CE. TCI state switch for PDSCH is triggered using combination of MAC CE and DCI. Active TCI state switch for PDSCH is triggered using DCI.

TCI switch delay depends on the TCI state known status. As per TS 38.133 V15.6.0, The TCI state is known if it has been meeting the following conditions: TCI state switch is within [X] ms of last transmission for beam reporting/measurement for the target TCI state, The UE has sent at least 1 measurement report for the target TCI state, The TCI state shall remain detectable during the TCI state switching period, SNR of the TCI state is >−3 dB, Otherwise, the TCI state is unknown.

The gNB may ask UE to switch to known or unknown TCI state based on the time when the beam report is received from UE.

In context of this document, beam and TCI state are used interchangeably. They both carry same meaning, unless otherwise stated L1-RSRP is part of CSI-report. In the context of this document, CSI report and L1-RSRP report, L1-RSRP are used interchangeably. They both carry same meaning unless otherwise stated T_{First_CSI}: First CSI report instance after TCI switch command.

According to 4G standards and/or current 5G standards, TCI state known status mismatch at gNB and UE cannot be handled according to 5G requirement.

TCI state switch delay depends on TCI state is known to UE or not. TCI state can be considered known at UE if the beam report is sent by UE less than [X] milliseconds (ms) ago. UE TCI state can be considered known at gNB if beam report is received by gNB less than [X] ms ago.

[X] May depend on UE speed and power class. Since UE speed may not be known at gNB, which may lead to mismatch in the assumption/estimation of [X] at gNB. Which results in the inaccurate TCI state known status of UE at gNB.

Accurate assumption of TCI state known to UE at gNB is required for effective determination of TCI switching delays. When the assumption at gNB about the TCI state known to UE is incorrect, it results in inaccurate assumption of TCI switch delay requirements at gNB and UE, which results in suboptimal performance. As a result, performance degradation or loss of scheduling opportunities will occur during NR TCI state switch.

### CITATION LIST

### Non Patent Literature

NPL 1: 3GPP TR 23.734, “Study on 5GS Enhanced support of Vertical and LAN Services”, V1.0.0 (2018 December)
NPL 2: 3GPP TS 31.101, “UICC-terminal interface; Physical and Logical characteristics”, V15.1.0 (2018 October), Rel-15
NPL 3: 3GPP TR 33.819, “Study on security enhancement of 5GS for vertical and LAN services”, V0.3.0 (2019 March), Rel-16
NPL 4: 3GPP TR 21.905, “Vocabulary for 3GPP Specifications”, V15.0.0 (2018 March)
NPL 5: 3GPP TS 22.261, “Service requirements for the 5G system”, V16.5.0 (2018 September)
NPL 6: 3GPP TS 31.102, “Characteristics of the Universal Subscriber Identity Module (USIM) application”, V15.5.0 (2019 March), Rel-15

### SUMMARY OF INVENTION

### Technical Problem

In view of the problems described above, the present disclosure aims to provide a solution to solve at least one of the various problems.

### Solution to Problem

A method of reporting channel state information, CSI, to a radio station by a user equipment, UE, comprising the steps of: measuring at least one beam for a beam measurement report and a CSI report; sending the beam measurement report of the at least one beam to the radio station; receiving, from the radio station, a transmission configuration indicator, TCI, state indication in response to the beam measurement report of the at least one beam; measuring at least one specific beam indicated by the TCI state indication to acquire the CSI of the at least one specific beam; wherein sending a valid CSI report of the at least one specific beam, if the beam measurement report of the at least one specific beam was transmitted within a predetermined time; and sending a partially valid CSI report or an invalid CSI report of the at least one specific beam, if the beam measurement report of the at least one specific beam was transmitted more than a predetermined time ago.

A communication system for reporting channel state information, CSI, comprising: a radio station; a user equipment, UE, wherein: the UE is configured to measure at least one beam for a beam measurement report and a CSI report, from the radio station; and to send the beam measurement report of the at least one beam to the radio station; wherein the radio station is configured to send a transmission configuration indicator, TCI, state indication, to the UE, in response to the beam measurement report of the at least one beam; wherein the UE is configured to measure at least one specific beam indicated by the TCI state indication to acquire the CSI of the at least one specific beam; and to send a valid CSI report of the at least one specific beam, if the beam measurement report was transmitted within a predetermined time; and sending, a partially valid CSI report or an invalid CSI report of the at least one specific beam, if the beam measurement report was transmitted more than a predetermined time ago.

A method of scheduling TCI for a UE by a radio station, comprising the steps of: registering the UE; receiving at least one beam measurement report; transmitting, a transmission configuration indicator state indication based on the received measurement report which consists of at least one beam; receiving an updated TCI state known status implicitly using type of CSI report during and upon acquisition of said TCI state by the UE; wherein receiving, a valid CSI report of the at least one specific beam, if the beam measurement report was received within a predetermined time; and receiving, a partially valid CSI report or an invalid CSI report of the at least one specific beam, if the beam measurement report was received more than a predetermined time ago; and adjusting the TCI switching delay based on the type of CSI report received.

### BRIEF DESCRIPTION OF DRAWINGS

FIG. 1 illustrates multiple beams transmission.

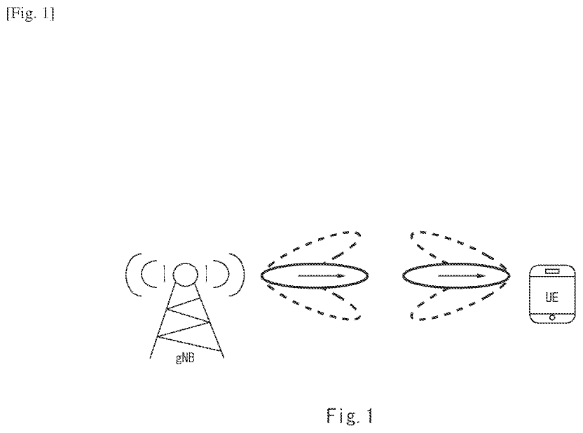

FIG. 2 illustrates a flow diagram of the UE behaviour in accordance with the present disclosure.

FIG. 3 illustrates UE behaviour when beam report is sent less than a predetermined time ago, according to the present disclosure.

FIG. 4 illustrates UE behaviour when beam report is sent more than a predetermined time ago and UE TCI state known status is TCI state unknown/not known in accordance with the present disclosure.

FIG. 5 illustrates a UE behaviour when beam report is sent more than a predetermined time ago and UE TCI state known status is TCI state known in accordance with the present disclosure.

FIG. 6 illustrates UE behaviour when beam report is sent more than a predetermined time ago, in accordance with the present disclosure.

FIG. 7 illustrates UE behaviour when beam report is sent more than a predetermined time ago and UE TCI state known status is TCI state unknown/not known at UE in accordance with the present disclosure.

FIG. 8 illustrates an alternative wherein UE behaviour when beam report is sent more than a predetermined time ago and UE TCI state known status is TCI state unknown/not known at UE in accordance with the present disclosure.

FIG. 9 illustrates UE behaviour when beam report is sent more than a predetermined time ago and UE TCI state known status is TCI state known in accordance with the present disclosure.

FIG. 10 illustrates CSI evaluation and CSI classification at UE, in accordance with the present disclosure.

FIG. 11 illustrates gNB behaviour for the UE behaviour, in accordance with the present disclosure.

FIG. 12 illustrates gNB behaviour when beam report was received more than a predetermined time ago (when TCI state indication sent) and UE sends valid CSI report, in accordance with the present disclosure.

FIG. 13 illustrates gNB behaviour when beam report was received more than a predetermined time ago (when TCI state indication sent) and UE sends invalid/partially valid CSI report in accordance with the present disclosure.

FIG. 14 illustrates gNB behaviour when beam report was received more than a predetermined time ago (when TCI state indication sent) and UE sends invalid/partially valid CSI report in accordance with the present disclosure.

FIG. 15 illustrates UE behaviour and gNB behaviour during TCI switching error cases, in accordance with the present disclosure.

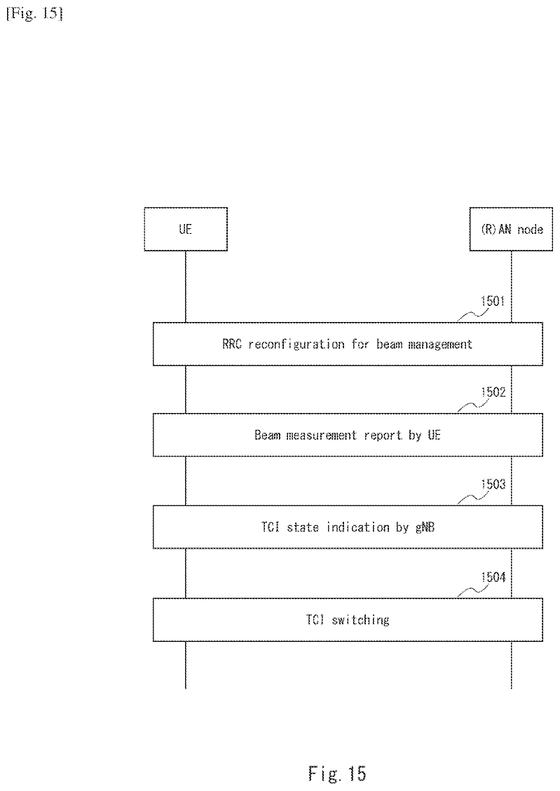

FIG. 16 illustrates UE behaviour when beam report was sent less than predetermined time but UE TCI state known status is TCI state unknown/not known/no longer known in accordance with the present disclosure.

FIG. 17 illustrates an alternate solution of UE behaviour when beam report sent less than predetermined time but UE TCI state known status is TCI state unknown/not known/no longer known in accordance with the present disclosure.

FIG. 18 illustrates gNB behaviour when beam report was received less than predetermined time (when TCI state indication issued) but UE sends partially valid or invalid CSI report in accordance with the present disclosure.

FIG. 19 illustrates an alternate solution of gNB behaviour when beam report was received less than predetermined time (when TCI state indication command issued) but UE sends partially valid or invalid CSI report in accordance with the present disclosure.

FIG. 20 illustrates general block diagram for UE in accordance with the present disclosure.

FIG. 21 illustrates general block diagram for (R)AN in accordance with the present disclosure.

FIG. 22 illustrates a general block diagram for Core Network Node in accordance with the present disclosure.

### DESCRIPTION OF EMBODIMENTS

The following description particularly describes the invention and the manner in which it is to be performed.

The foregoing and further objects, features and advantages of the present subject matter will become apparent from the following description of exemplary embodiments with reference to the accompanying drawings, wherein like numerals are used to represent like elements.

It is to be noted, however, that the appended drawings along with the reference numerals illustrate only typical embodiments of the present subject matter, and are therefore, not to be considered for limiting of its scope, for the subject matter may admit to other equally effective embodiments.

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

It is to be noted, however, that the reference numerals in claims illustrate only typical embodiments of the present subject matter, and are therefore, not to be considered for limiting of its scope, for the subject matter may admit to other equally effective embodiments.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include operatively connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different. It is apparent to a person skilled in the art that the structure may also comprise other functions and structures.

Also, all logical units described and depicted in the figures include the software and/or hardware components required for the unit to function. Further, each unit may comprise within itself one or more components which are implicitly understood. These components may be operatively coupled to each other and be configured to communicate with each other to perform the function of the said unit.

### Abbreviations

For the purposes of the present document, the abbreviations given in 3GPP TR 21.905 (NPL 4) and the following apply. An abbreviation defined in the present document takes precedence over the definition of the same abbreviation, if any, in 3GPP TR 21.905 (NPL 4).

### 5GC 5G Core Network

### 5GS 5G System

### 5QI 5G QoS Identifier

### AMF Access and Mobility Management Function

### AS Access Stratum

### BWP Bandwidth Part

### CORESET COntrol REsource SET

### CP Cyclic Prefix

### CSI Channel State Information

### CSI-RS Channel State Information-Reference Signals

### DL Downlink

### MAC Medium Access Control

### MAC CE MAC Control Element

### NG-RAN Next Generation Radio Access Network

NR New Radio/NR radio access

### PBCH Physical Broadcast Channel

### PDCCH Physical Downlink Control Channel

### PDSCH Physical Downlink Shared Channel

### PUCCH Physical Uplink Control Channel

### PUSCH Physical Uplink Shared Channel

### QCL Quasi Co Location

### (R)AN (Radio) Access Network

### RRC Radio Resource Control

### RS Reference Signal

### SA NR Standalone NR

### SCS Sub Carrier Spacing

### SS Synchronization Signal

### SSB SS/PBCH Block

### TCI Transmission Configuration Indication

### UL Uplink

### OS Operating System

### MO Mobile Originated

### MT Mobile Terminated

### USIM Universal Subscriber Identity Module

The present disclosure relates to handling of TCI state known status mismatch at gNB and UE. More specifically, the present disclosure relates to different mechanisms to classify CSI report(s) into valid/partially valid/invalid CSI report(s) by defining a new CSI evaluation methodology. This present disclosure also discloses a new UE behaviour of sending different type of (valid/partially valid/invalid) CSI report to inform the gNB about the TCI state known status at the UE. Further, an implicit or explicit signalling method is adopted to inform the type of CSI to the gNB. The present disclosure further discloses new UE behaviour of skipping CSI reports between partially valid/invalid CSI report and valid CSI report during TCI state switching/SCell activation.

In the context of this document, TCI state indication, TCI state switch command, beam switch command are used interchangeably. All of them carry same meaning unless otherwise stated.

The following presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter.

In order to overcome at least the problems discussed above, the present disclosure provides solution in one aspect wherein reporting channel state information, CSI, to a radio station by a user equipment, UE, involves measuring at least one beam for beam measurement report and CSI report; sending the beam measurement report of the at least one beam to the radio station; receiving, from the radio station, a transmission configuration indicator, TCI, state indication in response to the beam measurement report of the at least one beam; measuring at least one specific beam indicated by the TCI state indication to acquire the CSI of the at least one specific beam; wherein sending a valid CSI report of the at least one specific beam, if the beam measurement report of the at least one specific beam was transmitted within a predetermined time; and sending a partially valid CSI report or an invalid CSI report of the at least one specific beam, if the beam measurement report of the at least one specific beam was transmitted more than a predetermined time ago. The UE is allowed to send the valid CSI report, if the UE successfully acquire the CSI of the at least one specific beam regardless of a timing of the beam measurement report of the at least one specific beam; wherein the valid CSI report uses value or values defined for successful CSI reporting wherein the UE successfully acquire the CSI, and whereas the partially valid CSI report or the invalid CSI report uses a value outside the defined value or values for the successful CSI reporting. The present disclosure also facilitates the plurality of CSI reports to be sent by UE to radio station, that are partially valid or invalid till UE acquires valid CSI report; or the plurality of CSI reports skipped by the UE, from sending to radio station, in between the partially valid or invalid CSI report and valid CSI report. Further, the CSI is measured by UE, on next available CSI resource for evaluation, during and upon acquisition of the specified beam. The PDSCH/PDCCH are received on a new TCI known state. Further, CSI report is categorized into partially valid or invalid CSI report, upon determination of an unknown beam at the UE wherein the partially valid CSI report is reported to the radio station, which also comprises of reporting of invalid CSI report to the radio station. The present disclosure also provides TCI state indication command to the UE upon determination of TCI state known status of the UE as TCI state known wherein providing TCI state indication command to the UE is done by configuring different TCI switching delay for the unknown TCI state of the UE.

In another embodiment of the present disclosure, a communication system for reporting channel state information, CSI, is provided which comprises of a radio station; a user equipment, UE, wherein the UE is configured to measure at least one beam for beam measurement report and CSI report, from the radio station; and to send the beam measurement report of the at least one beam to the radio station; wherein the radio station is configured to send a transmission configuration indicator, TCI, state indication, to the UE, in response to the beam measurement report of the at least one beam; wherein the UE is further configured to measure at least one specific beam indicated by the TCI state indication to acquire the CSI of the at least one specific beam; and to send a valid CSI report of the at least one specific beam, if the beam measurement report was transmitted within a predetermined time; and sending, a partially valid CSI report or an invalid CSI report of the at least one specific beam, if the beam measurement report was transmitted more than a predetermined time ago. The UE is also allowed to send the valid CSI report, if the UE successfully acquire the CSI of the at least one specific beam regardless of a timing of the beam measurement report of the at least one specific beam. It is to be noted that the valid CSI report comprises a value or values defined for successful CSI reporting and the partially valid CSI report or the invalid CSI report comprises a value outside the value or values defined for the successful CSI reporting. Further, the radio station is configured to receive the plurality of CSI reports for evaluation, which comprises of partially valid or invalid CSI report till it receives valid CSI report; or the radio station is also configured to skip the plurality of CSI reports for evaluation, which comprises of partially valid or invalid CSI report till it receives valid CSI report. The radio station of the present disclosure is also configured to receive CSI report for the acquired beam from UE; wherein the radio station transmits PDSCH/PDCCH on a new TCI state and is configured to categorize the CSI report into partially valid or invalid CSI report for the unknown beam. The radio station is further configured to receive partially valid CSI report as well as it is configured to receive invalid CSI report based on applicability. The radio station is further configured to transmit switching command to the UE upon determination of the TCI state known status of the UE as TCI state known and to transmit switching command to the UE by configuring different TCI switching delay for the unknown TCI state of the UE.

In an additional embodiment of the present disclosure, a method of scheduling TCI for a UE by a radio station is also provided; which comprises of registering the UE; receiving at least one beam measurement report; transmitting, a transmission configuration indicator state indication based on the received measurement report which consists of at least one beam; receiving an updated UE TCI state known status implicitly using different type of CSI report during and upon beam acquisition of said TCI state by the UE; wherein receiving, a valid CSI report of the at least one specific beam, if the beam measurement report was received within a predetermined time; and receiving, a partially valid CSI report or an invalid CSI report of the at least one specific beam, if the beam measurement report was received more than a predetermined time ago; and adjusting the TCI switching delay based on the type of CSI report received. In the present disclosure the radio station, receives plurality of CSI reports from the UE for evaluation which comprises of partially valid or invalid CSI report till it receives valid CSI report; or skipping the plurality of CSI reports from the UE for evaluation in between the partially valid or invalid CSI report and valid CSI report. Further, the transmission of PDSCH/PDCCH on a new TCI known state and receiving partially valid or invalid or valid CSI reports. The present disclosure also determines UE TCI known state for transmitting switching command and adjusting TCI switching delay according to the updated TCI state known status implicitly acquired from the partially valid or invalid or valid CSI report.

### First Embodiment

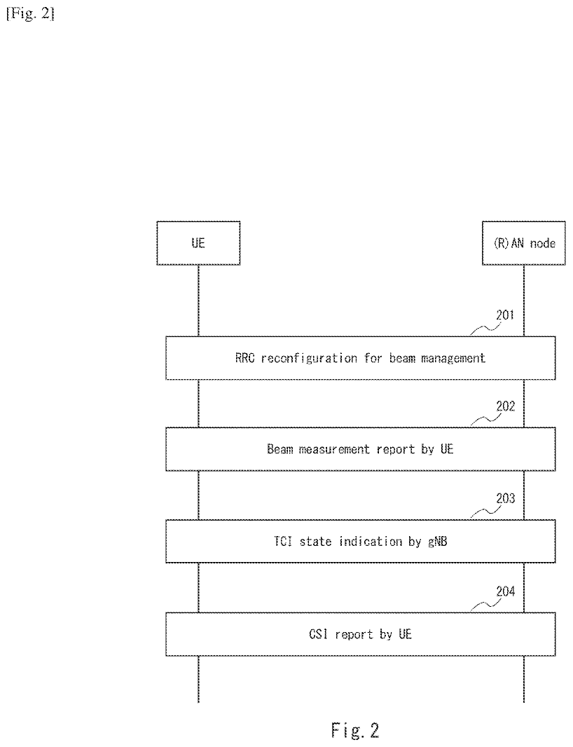

In an embodiment (first embodiment) of the present disclosure and as shown in FIG. 2, the detailed steps describe the UE behaviour when the beam report is sent less than predetermined time ago and more than predetermined time ago to solve problem existed in the prior art. The flow of the UE behaviour is outlined below.

At 201, the RRC reconfiguration for beam management is initiated. At 202, beam measurement report by UE is provided.

At 203, the TCI state switch command by gNB is provided.

At 204, CSI report by UE is provided and as part of this, UE have to perform TCI state acquisition, CSI computation and evaluation. The CSI report by UE is based on applicability and is categorized, wherein if beam report is sent less than predetermined time ago, then UE shall send valid CSI report, if beam report is sent more than predetermined time ago and if UE cannot acquire beam (i.e. beam is not known), UE sends invalid (or partially valid) CSI report. However, if UE can acquire beam (i.e. beam is known), UE shall send valid CSI report. The valid CSI report is for example the same as legacy CSI report, where it is assumed that the UE can acquire the intended beam successfully.

In detail, at 201, once UE is RRC connected, gNB configures UE with SSB/CSI-RS for beam management through RRC reconfiguration. gNB may configure UE with multiple SSB/CSI-RS resources for CSI measurement and multiple reporting configurations for CSI measurement report through RRC reconfiguration. At 202, UE performs measurements on the configured measurement resources and reports the measurement report on the configured measurement reporting instance. This measurement report may contain serving beam and/or neighboring beams based on configuration from gNB. Number of beams to be reported is configurable by gNB. Though UE may be measuring in every measurement instance (that is every RS transmission instance), UE will be reporting to gNB only in measurement reporting instance. Number of measurement instances and number of reporting instances may not be same.

For example, by considering a scenario where, gNB may be using 8 beams (beam index or TCI state 1, 2, 3 . . . 8) to transmit across the coverage area of the cell. gNB may configure UE to measure one or more beams (for example beam index or TCI state 4, 6, 8). UE measures beams corresponding to beam index 4, 6, and 8 when the measurement resources are available, and reports beam measurement report of beam index 4, 6 and 8 to gNB when reporting resources are available.

At 203, based on the beam measurement report from UE, whenever there is a stronger beam (beam index 6 may be stronger in the example described above) than the serving beam (for example beam index or TCI state of serving beam index is 1), gNB may initiate a TCI state switch by issuing a TCI state indication for switching the PDCCH or PDSCH TCI state (i.e. switch to beam index 6 from current serving beam index 1 in the example described above). Upon receiving the TCI state indication/TCI state switch command (i.e. switch to beam index or TCI state 6 in the example described above), via PDCCH (DCI command) or PDSCH (MAC CE or RRC), UE should be able switch to new TCI state with in the TCI switch delay (T_{TCI_Switch_Delay}) as defined (NPL 5) below.

DCI based TCI switch delay:

If target TCI state is known:
T_{TCI_Switch_Delay}=timeDurationForQCL

MAC-CE based TCI state switch delay:

If target TCI state is known:
T_{TCI_Switch_Delay}=T_{HARQ}+3 ms+TOₖ*(T_{first-SSB}+T_{SSB-proc})

If Target TCI state is unknown:
T_{TCI_Switch_Delay}=T_{HARQ}+3 ms+T_{L1-RSRP}+TOᵤₖ*(T_{first-SSB}+T_{SSB-proc})

RRC based TCI state delay:

If target TCI state is known:
T_{TCI_Switch_Delay}=T_{RRC_processing}+TOₖ*(T_{first-SSB}+T_{SSB-proc})

If Target TCI state is unknown:
T_{TCI_Switch_Delay}=T_{RRC_processing}+T_{L1-RSRP}+TOᵤₖ*(T_{first-SSB}+T_{SSB-proc})

Where,

timeDurationForQCL is the time required by the UE to perform PDCCH reception and applying spatial QCL information received in DCI for PDSCH processing (NPL 6);

T_{HARQ} is the timing between DL data transmission and acknowledgement;

T_{first-SSB} is time to first SSB transmission after TCI state command is received by the UE; T_{SSB-proc}=2 ms;

TOₖ=1 if target TCI state is not in the active TCI state list for PDSCH, 0 otherwise;

TOᵤₖ=1 for CSI-RS based L1-RSRP measurement, and 0 for SSB based L1-RSRP measurement;

T_{L1-RSRP} is the time for L1-RSRP measurement for Rx beam refinement;

T_{RRC_processing} is the RRC processing delay.

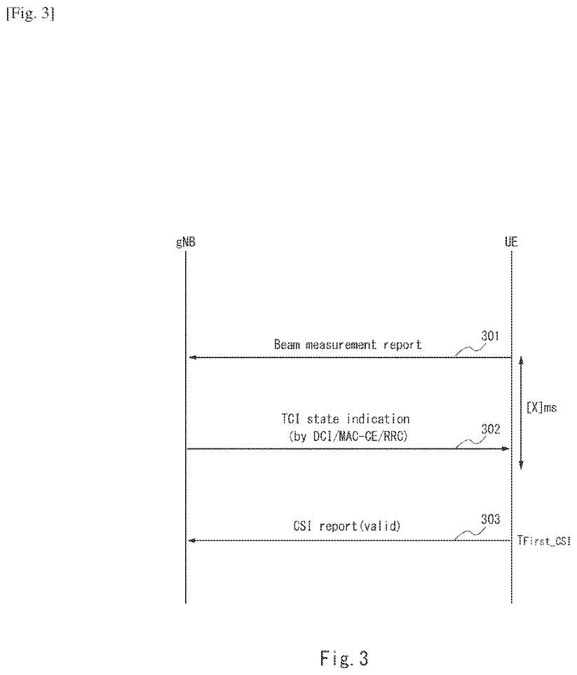

At 204, when UE receives TCI state indication (for example beam index 6 in the example described above)/TCI switch command through PDSCH (MAC CE or RRC) or PDCCH (DCI command), UE may start procedure of beam acquisition (beam index 6 in the example described above) and measures the CSI on the next available CSI resources which may be SSB/CSI-RS and perform CSI report evaluation. Based on the beam reported instance (time), UE sends the CSI report as described below. If the beam report, beam measurement report 301, is sent less than [X] ms ago, i.e., if TCI state indication 302 is sent within [X] ms from the report 301, UE shall send valid CSI report 303 as shown in FIG. 3.

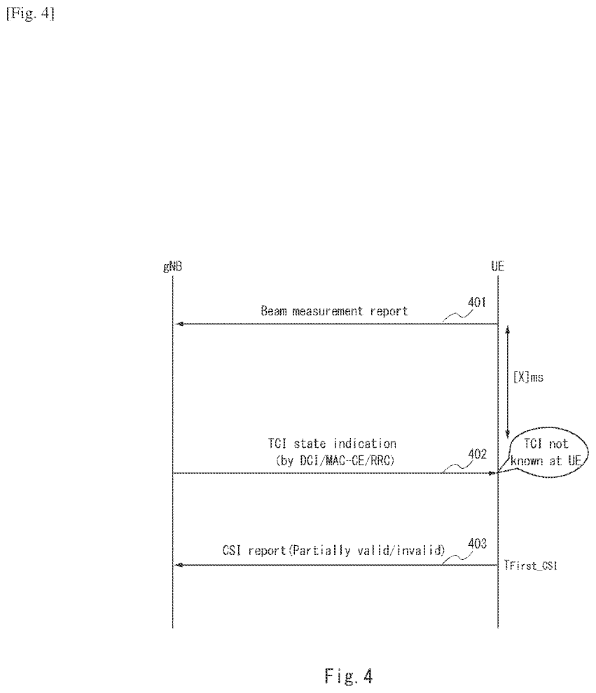

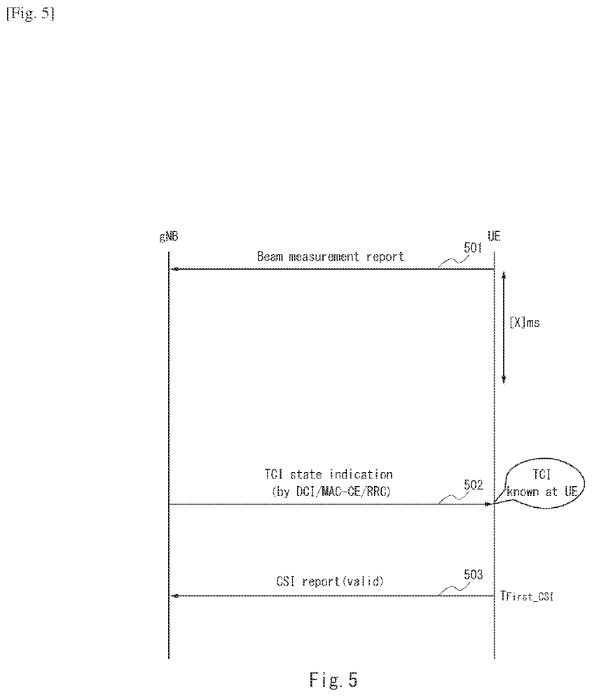

As shown in FIG. 4, if the beam report, beam measurement report 401, is sent more than predetermined time ago, i.e., if TCI state indication 402 is sent after a time more than the predetermined time (ex. [X] ms) from the report 401, and if TCI state is not known to UE, UE should start performing the beam acquisition procedure. When CSI reporting resources are available, UE shall send partially valid or invalid CSI report 403. Partially valid or invalid CSI report may mean any value(s) which is not used in the normal (i.e. valid CSI report) CSI reporting, or any value(s) which is defined for the case where the UE cannot get the valid (i.e. appropriate) CSI. It is also possible that the invalid CSI report and the partially valid CSI report are the same or different from each other. Existing CSI (L1-RSRP) reporting table(s) of (NPL 5) may be used for indicating invalid and partially valid CSI reporting to gNB. As shown in FIG. 5, if TCI state is known when UE receives TCI state indication 502 in response to beam measurement report 501, UE shall send valid CSI report 503.

### Second Embodiment

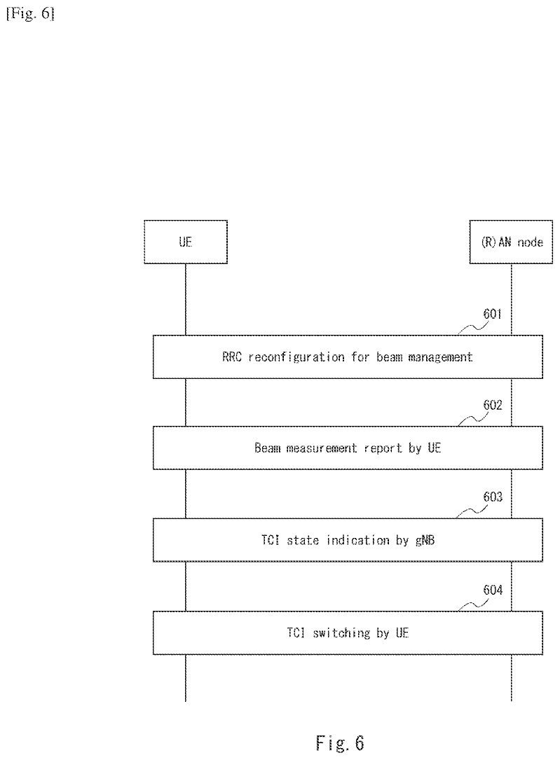

As shown in FIG. 6, another embodiment (second embodiment) describes UE behaviour w.r.t CSI reporting when beam report is sent more than predetermined time ago, to solve problem statement. The flow of the UE behaviour is outlined below.

At 601, RRC reconfiguration for beam management is initiated.

At 602, Beam measurement report by UE is provided.

At 603, TCI state indication by gNB is provided.

At 604, TCI switching by UE is performed. As part of this UE have to perform TCI state acquisition, TCI state known status update, CSI computation and evaluation and CSI reporting based on applicability; wherein If beam report is sent less than predetermined time ago, UE shall send valid CSI report and if beam report is sent more than predetermined time ago and if UE cannot acquire the beam (i.e. beam is unknown or not known), UE sends invalid (or partially valid) CSI report till UE acquires TCI state (beam). Upon TCI state acquisition (i.e. beam is known now) UE sends valid CSI report. If beam is known, UE shall send valid CSI report on the first CSI reporting instance and UE switch to new TCI state.

In detail, at 601, gNB configures UE with measurement resources and measurement reporting resources. At 602, based on the measurement resources and measurement reporting configuration, UE measures and report beam measurements to gNB.

At 603, based on the beam measurement report, gNB may send a TCI state indication if any stronger TCI state is found in beam report.

At 604, when UE receives TCI state indication through PDSCH (MAC CE or RRC) or PDCCH (DCI command), the UE may start procedure of beam acquisition, UE may update TCI state known status, measures the CSI and perform the CSI report evaluation. Based on the beam report instance (time), UE sends the CSI report as described below.

If the beam report is sent less than [X] ms ago, UE shall send valid CSI report.

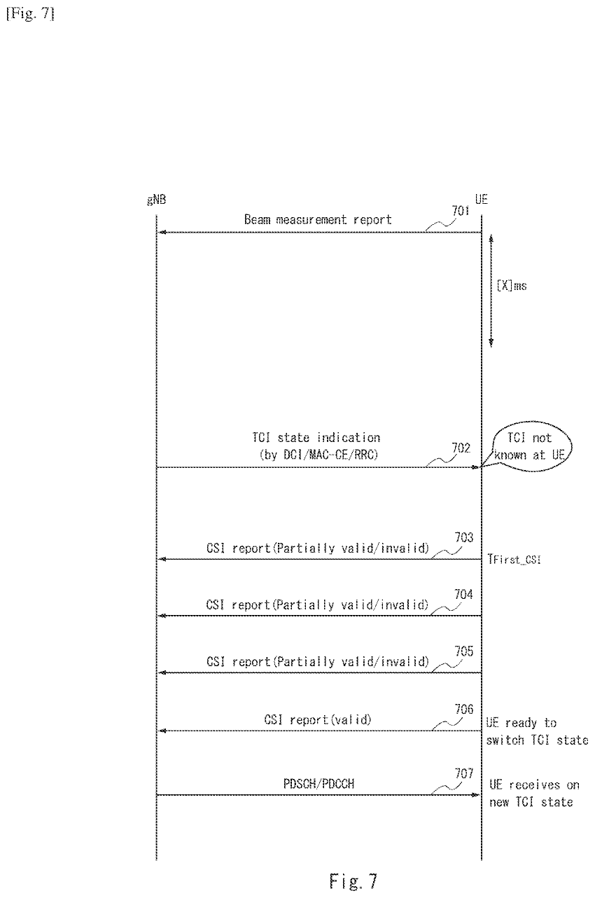

If the beam report, beam measurement report 701, is sent more than [X] ms ago, i.e., if TCI state indication 702 is sent after a time more than [X] ms from the report 701, as shown in FIG. 7, and if TCI state is not known to UE, UE should start performing the beam acquisition procedure. When CSI reporting resources are available, UE shall send partially valid or invalid CSI report(s) 703-705 till UE completes beam acquisition procedure. Upon TCI state acquisition, UE should send valid CSI report 706. UE prepare to switch TCI state and PDSCH/PDCCH 707 is received on the new TCI state. Partially valid or invalid CSI report may mean any value(s) which is not used in the normal (i.e. valid CSI report) CSI reporting, or any value(s) which is defined for the case where the UE cannot get the valid (i.e. appropriate) CSI. It is also possible that the invalid CSI report and the partially valid CSI report are the same or different from each other. Existing CSI (L1-RSRP) reporting table(s) of (NPL 5) may be used for indicating invalid and partially valid CSI report to gNB.

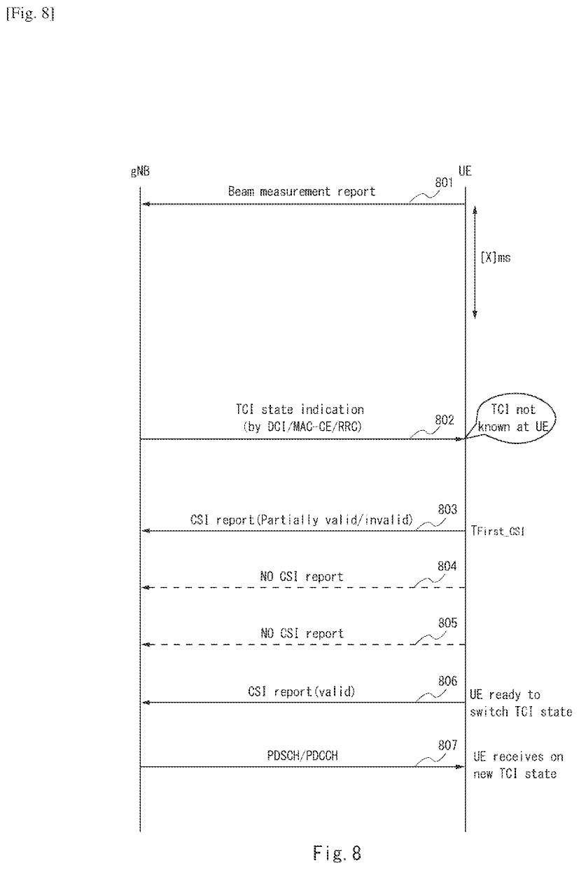

Alternate solution for this problem is shown in FIG. 8. If the beam measurement report 801 is sent more than [X] ms ago, i.e., if TCI state indication 802 is sent after a time more than [X] ms from the report 801, and if TCI state is not known to UE, between first instance of (partially valid/invalid) CSI report 803 and till UE completes beam acquisition and sends valid CSI report 806, UE shall not send any CSI reports 804-805. That means even though gNB configures a UE with CSI reporting resources, since first CSI report is partially valid or invalid CSI report, subsequent reports till the valid CSI report, are also partially valid or invalid CSI reports, it means that gNB is not getting any useful information from the UE. Hence it is beneficial to skip the CSI reports in between the partially valid/invalid CSI reports to valid CSI report even when UE has CSI reporting resources configured. Time till which UE does not send CSI reports can be configured. UE prepare to switch TCI state and receives PDSCH/PDCCH 807 on the new TCI state.

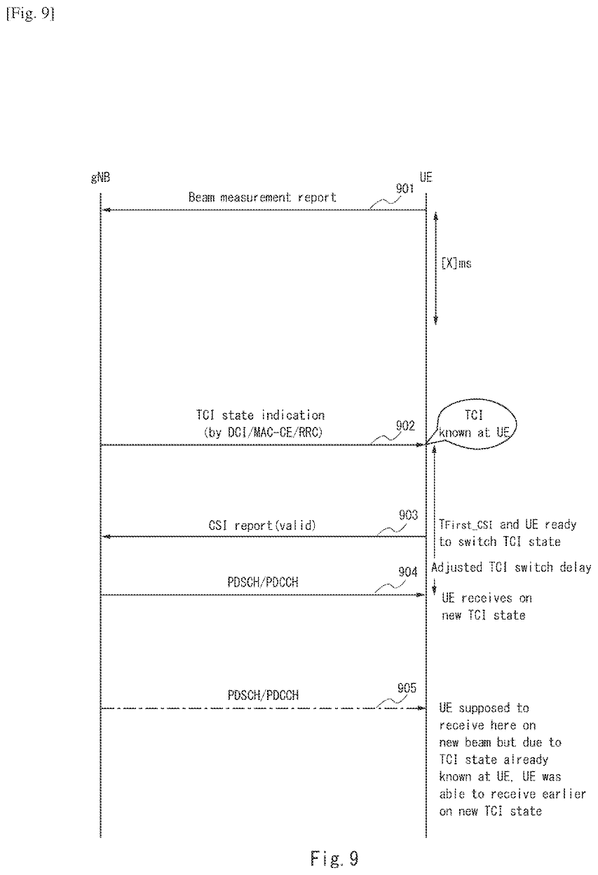

As shown in FIG. 9, if the beam measurement report 901 is sent more than [X] ms ago, i.e., if TCI state indication 902 is sent after a time more than [X] ms from the report 901, and if TCI state is known, UE shall send valid CSI report 903 on first instance of CSI reporting after TCI switch command. TCI switch delay should be updated to TCI switch delay (known). UE expected to receive PDCCH/PDSCH 904 on new TCI state at the end of TCI state switch delay corresponding to TCI state known. UE switches to new TCI state and subsequent PDSCH/PDCCH 905 is received on the new TCI state.

### Third Embodiment

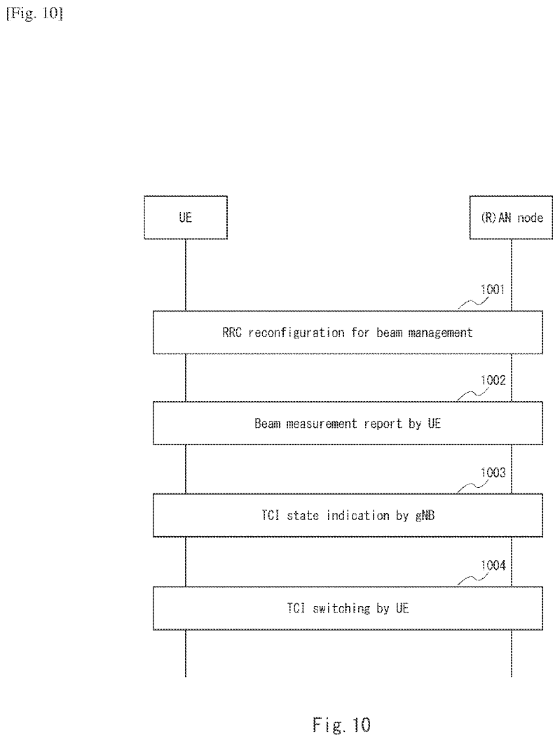

Another embodiment (third embodiment) of the present disclosure describes CSI evaluation and CSI classification at UE to solve the problem statement. Outline of the solution is described below as well as illustrated in FIG. 10. Entire flow of the solution is divided into four steps and outline of the solution is described below.

At 1001, RRC reconfiguration for beam management is initiated.

At 1002, Beam measurement report by UE is provided.

At 1003, TCI state indication by gNB is provided.

At 1004, TCI switching by UE is performed. As part of this UE have to perform, TCI state acquisition, TCI state known status update, CSI computation and evaluation; wherein if UE cannot acquire the beam (i.e. beam is unknown at UE) UE CSI report is classified into partially valid/invalid CSI report; UE also has to send CSI report based on the applicability, upon which the UE switch to new TCI state.

In detail, at 1001, gNB configures UE with measurement resources and measurement reporting resources. At 1002, based on the measurement resources and measurement reporting configuration UE measures and report beam measurements to gNB. At 1003, based on the beam measurement report, gNB may send a TCI state indication if any stronger TCI state is found in beam report. At 1004, when UE receives TCI state indication through PDSCH (MAC CE or RRC) or PDCCH (DCI command), the UE starts procedure of beam acquisition, updates TCI state known status, measures the CSI and perform the CSI report evaluation as described below.

TCI state known status update at UE upon reception of TCI state indication:

Upon reception of TCI state indication/TCI state switch command, UE may start acquiring target beam and may update the TCI state known status as described below.
If the TCI state is detectable, then the beam is considered known and UE may update TCI state known status to TCI state known.
If the TCI state is not detectable, then the beam is considered unknown and UE may update TCI state known status to TCI state unknown.

Partially Valid CSI report: If UE can detect and measure the beam and measured L1-RSRP value satisfies following criteria of Y<|CSI_Report_latest−CSI_Report_prev|<Z dBm. Where CSI_Report_latest is the latest measured CSI report after receiving the TCI state indication and CSI_Report_prev is the last reported CSI report value before receiving the TCI switch command.

Invalid CSI report: If UE can't detect the beam, it reports an invalid L1-RSRP.

Y and Z values in the above method are configurable.

Upon performing the CSI report evaluation, UE reports the CSI based on the evaluation result. At each CSI reporting instance, UE should report based on the reporting configuration. Which may involve target TCI state and other TCI states according to reporting configuration. The reported value is determined as described below.

L1-RSRP Reporting:

L1-RSRP report may be part of CSI report. For L1-RSRP reporting, if the higher layer parameter nrofReportedRS in CSI-ReportConfig is configured to be one, the reported L1-RSRP value is defined by a 7-bit value in the range [−140, −44] dBm with 1 dB step size, if the higher layer parameter nrofReportedRS is configured to be larger than one, or if the higher layer parameter groupBasedBeamReporting is configured as ‘enabled’, the UE shall use differential L1-RSRP based reporting, where the largest measured value of L1-RSRP is quantized to a 7-bit value in the range [−140, −44] dBm with 1 dB step size, and the differential L1-RSRP is quantized to a 4-bit value. The differential L1-RSRP value is computed with 2 dB step size with a reference to the largest measured L1-RSRP value which is part of the same L1-RSRP reporting instance. The mapping between the reported L1-RSRP value and the measured quantity is described in Table 1 and Table 2, which are described in TS 38.133, (NPL 5).

Signalling Design of Partially Valid/Invalid CSI Report:

CSI report can be signaled using implicit or explicit signalling. Implicit signalling implies using existing L1-RSRP table, UE indicates the type of CSI report to gNB. In table 1, RSRP_0 to RSRP_15 and RSRP_114 to RSRP_126 are not used for L1-RSRP reporting, as the reporting range of L1-RSRP is [−140 to −44] dBm. In the table 1, these values are indicated as not valid.

Implicit Method:

In this method, the unused/Not valid values of L1 SS-RSRP/CSI-RSRP quantity of table 1 are used to convey more accurate CSI type information to gNB.

To report partially valid CSI, UE may use any unused L1-RSRP values (“Not valid”) of Table 1 (NPL 5). For example UE may use any value in the range from RSRP_0 to RSRP_15. It just informs gNB that CSI is partially valid. It won't give any information on signal strength.

To report invalid CSI, UE may use any unused L1-RSRP values (“Not valid”) of Table 1 (NPL 5). For example UE may use any value in the range from RSRP_114 to RSRP_126. It just informs gNB that CSI is invalid. It won't give any information on signal strength.

a. Upon determining the type of CSI and CSI value to be reported, UE reports CSI report based on the applicability

b. When UE is ready with Rx spatial filter direction to receive the beam, UE switches to new TCI state. Upon UE switch to new TCI state, subsequent PDSCH/PDCCH is received on the new TCI state

TABLE 1
Differential SS-RSRP and CSI-RSRP measurement report mapping

| | Measured quantity value(difference in | |
|---|---|---|
| Reported value | measured RSRP from strongest RSRP) | Unit |
| DIFFRSRP_0 | 0 ≥ ΔRSRP ≥ −2 | dB |
| DIFFRSRP_1 | −2 ≥ ΔRSRP ≥ −4 | dB |
| DIFFRSRP_2 | −4 ≥ ΔRSRP ≥ −6 | dB |
| DIFFRSRP_3 | −6 ≥ ΔRSRP ≥ −8 | dB |
| DIFFRSRP_4 | −8 ≥ ΔRSRP ≥ −10 | dB |
| DIFFRSRP_5 | −10 ≥ ΔRSRP ≥ −12 | dB |
| DIFFRSRP_6 | −12 ≥ ΔRSRP ≥ −14 | dB |
| DIFFRSRP_7 | −14 ≥ ΔRSRP ≥ −16 | dB |
| DIFFRSRP_8 | −16 ≥ ΔRSRP ≥ −18 | dB |
| DIFFRSRP_9 | −18 ≥ ΔRSRP ≥ −20 | dB |
| DIFFRSRP_10 | −20 ≥ ΔRSRP ≥ −22 | dB |
| DIFFRSRP_11 | −22 ≥ ΔRSRP ≥ −24 | dB |
| DIFFRSRP_12 | −24 ≥ ΔRSRP ≥ −26 | dB |
| DIFFRSRP_13 | −26 ≥ ΔRSRP ≥ −28 | dB |
| DIFFRSRP_14 | −28 ≥ ΔRSRP ≥ −30 | dB |
| DIFFRSRP_15 | −30 ≥ ΔRSRP | dB |

TABLE 2
SS-RSRP and CSI-RSRP measurement report mapping

| | | Measured quantity value(L1 SS-RSRP | |
|---|---|---|---|
| Reported value | Measured quantity value(L3 SS-RSRP) | and CSI-RSRP) | Unit |
| RSRP_0 | SS-RSRP ≤ −156 | Not valid | dBm |
| RSRP_1 | −156 ≤ SS-RSRP ≤ −155 | Not valid | dBm |
| RSRP_2 | −155 ≤ SS-RSRP ≤ −154 | Not valid | dBm |
| RSRP_3 | −154 ≤ SS-RSRP ≤ −153 | Not valid | dBm |
| RSRP_4 | −153 ≤ SS-RSRP ≤ −152 | Not valid | dBm |
| RSRP_5 | −152 ≤ SS-RSRP ≤ −151 | Not valid | dBm |
| RSRP_6 | −151 ≤ SS-RSRP ≤ −150 | Not valid | dBm |
| RSRP_7 | −150 ≤ SS-RSRP ≤ −149 | Not valid | dBm |
| RSRP_8 | −149 ≤ SS-RSRP ≤ −148 | Not valid | dBm |
| R5RP_9 | −148 ≤ SS-RSRP ≤ −147 | Not valid | dBm |
| RSRP_10 | −147 ≤ SS-RSRP ≤ −146 | Not valid | dBm |
| RSRP_11 | −146 ≤ SS-RSRP ≤ −145 | Not valid | dBm |
| RSRP_12 | −145 ≤ SS-RSRP ≤ −144 | Not valid | dBm |
| RSRP_13 | −144 ≤ SS-RSRP ≤ −143 | Not valid | dBm |
| RSRP_14 | −143 ≤ SS-RSRP ≤ −142 | Not valid | dBm |
| RSRP_15 | −142 ≤ SS-RSRP ≤ −141 | Not valid | dBm |
| RSRP_16 | −141 ≤ SS-RSRP ≤ −140 | RSRP ≤ −140 | dBm |
| RSRP_17 | −140 ≤ SS-RSRP ≤ −139 | −140 ≤ RSRP ≤ −139 | dBm |
| RSRP_18 | −139 ≤ SS-RSRP ≤ −138 | −139 ≤ RSRP ≤ −138 | dBm |
| . . . | . . . | . . . | . . . |
| RSRP_111 | −46 ≤ SS-RSRP ≤ −45 | −46 ≤ RSRP ≤ −45 | dBm |
| RSRP_112 | −45 ≤ SS-RSRP ≤ −44 | −45 ≤ RSRP ≤ −44 | dBm |
| RSRP_113 | −44 ≤ SS-RSRP ≤ −43 | −44 ≤ RSRP | dBm |
| RSRP_114 | −43 ≤ SS-RSRP ≤ −42 | Not valid | dBm |
| RSRP_115 | −42 ≤ SS-RSRP ≤ −41 | Not valid | dBm |
| RSRP_116 | −41 ≤ SS-RSRP ≤ −40 | Not valid | dBm |
| RSRP_117 | −40 ≤ SS-RSRP ≤ −39 | Not valid | dBm |
| RSRP_118 | −39 ≤ SS-RSRP ≤ −38 | Not valid | dBm |
| RSRP_119 | −38 ≤ SS-RSRP ≤ −37 | Not valid | dBm |
| RSRP_120 | −37 ≤ SS-RSRP ≤ −36 | Not valid | dBm |
| RSRP_121 | −36 ≤ SS-RSRP ≤ −35 | Not valid | dBm |
| RSRP_122 | −35 ≤ SS-RSRP ≤ −34 | Not valid | dBm |
| RSRP_123 | −34 ≤ SS-RSRP ≤ −33 | Not valid | dBm |
| RSRP_124 | −33 ≤ SS-RSRP ≤ −32 | Not valid | dBm |
| RSRP_125 | −32 ≤ SS-RSRP ≤ −31 | Not valid | dBm |
| RSRP_126 | −31 ≤ SS-RSRP | Not valid | dBm |
| RSRP_127 | Infinity | Infinity | dBm |
| (Note) | | | |

### Fourth Embodiment

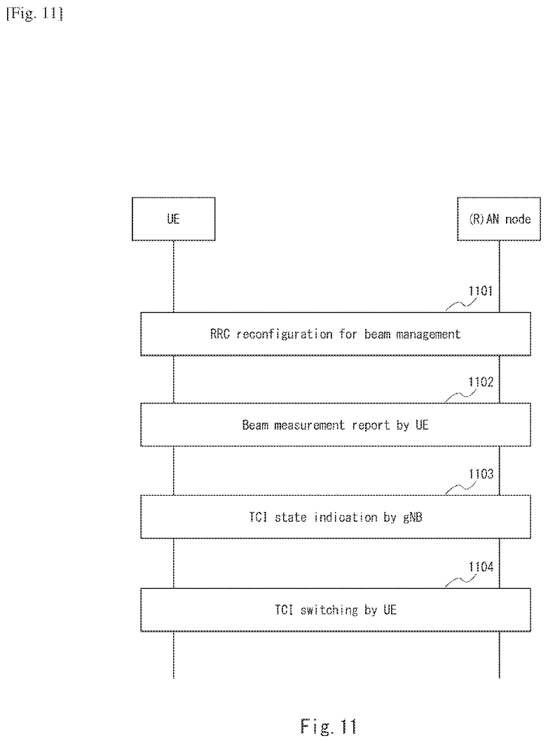

Another embodiment (fourth embodiment) of the present disclosure describes the gNB behaviour for TCI scheduling and CSI report handling. Outline of the solution is described below as well as illustrated in FIG. 11. Entire flow of the solution is divided into four steps and outlined below.

At 1101, RRC reconfiguration for beam management is initiated.

At 1102, Beam measurement report by UE is provided.

At 1103, TCI state indication by gNB is provided.

At 1104, TCI switching is performed, which comprises of TCI state acquisition at UE, TCI state (beam) known status update at UE (if UE can acquire the beam, beam is known; if UE cannot acquire the beam is unknown), CSI computation and evaluation at UE. CSI report by UE based on applicability. gNB behaviour for the TCI scheduling and CSI report handling. gNB transmits on new TCI state.

In detail, at 1101, gNB configures UE with measurement resources and measurement reporting resources. At 1102, based on the measurement resources and measurement reporting configuration, UE measures and report beam measurements to gNB. At 1103, based on the beam measurement report, gNB may send a TCI state indication if any stronger TCI state is found in beam report/beam measurement report. At 1104, when UE receives TCI state indication through PDSCH (MAC CE or RRC) or PDCCH (DCI command), the UE may start procedure of beam acquisition, UE may update TCI state known status, measures the CSI and perform the CSI report evaluation.

UE reports valid or invalid or partially valid CSI report.

gNB may receive valid CSI report from UE or gNB may receive partially valid or invalid CSI report from UE.

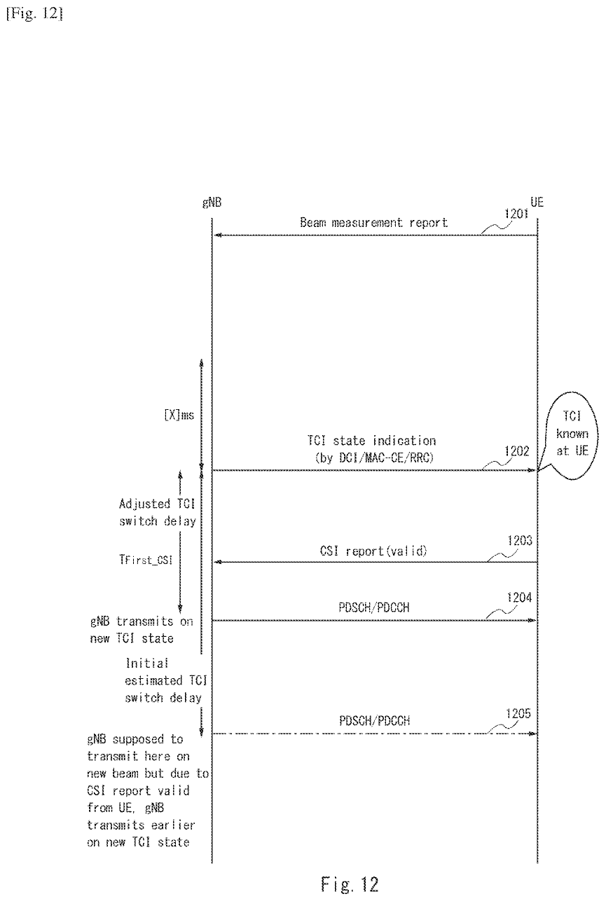

If gNB receives valid CSI report from UE:
i. If gNB assumption was that, TCI state of UE was known to UE when gNB issues TCI state indication, existing gNB behaviour follows.
ii. If gNB assumption was that, TCI state of UE is unknown/not known to UE when gNB issues TCI state indication to UE, gNB adjusts the TCI switching delay to TCI state switching delay corresponding to TCI state known. Which is also shown in FIG. 12. As shown in FIG. 12, if TCI state indication 1202 is sent after a time more than [X] ms from the report 1201, gNB assumes that UE knows TCI state when TCI state indication 1202 is issued and adjusts the TCI switch delay from initial estimated delay to delay corresponding to TCI state known by UE. UE shall send valid CSI report 1203 within the adjusted TCI switch delay and receive PDCCH/PDSCH 1204 on new TCI state at the end of the adjusted TCI state switch delay. Although gNB was supposed to transmit PDSCH/PDCCH 1205 at the end of the initial estimated TCI state switch delay, the gNB transmits PDSCH/PDCCH 1204 earlier on new TCI state because the CSI report 1203 from UE is valid.

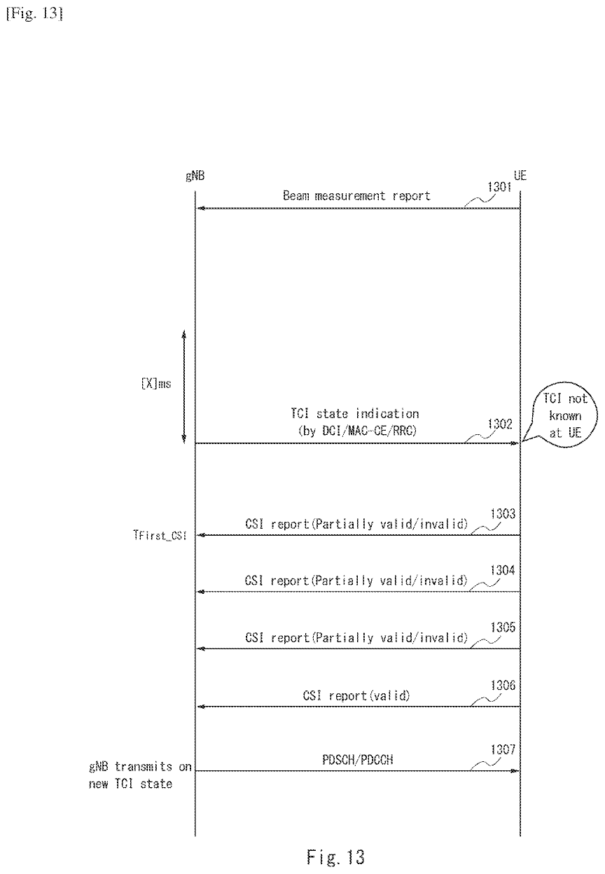

If gNB receives partially valid or invalid CSI report from UE:
i. If gNB assumption was that, TCI state of UE is unknown to UE when gNB issues TCI switch command, gNB knows that beam is not known at UE and waits for the valid CSI report to mark the completion of TCI state acquisition at UE. Till the valid CSI report 1306 is received, gNB expects UE to report invalid or partially valid CSI report(s) 1303-1305 as shown in FIG. 13. That is, if TCI state indication 1302 is sent after a time more than [X] ms from the report 1301 and if TCI state is not known to UE, UE shall send partially valid or invalid CSI report(s) 1303-1305 till UE completes beam acquisition procedure. Upon TCI state acquisition, UE should send valid CSI report 1306. Upon reception of valid CSI report 1306, gNB transmits PDSCH/PDCCH 1307 on the new TCI state to UE.

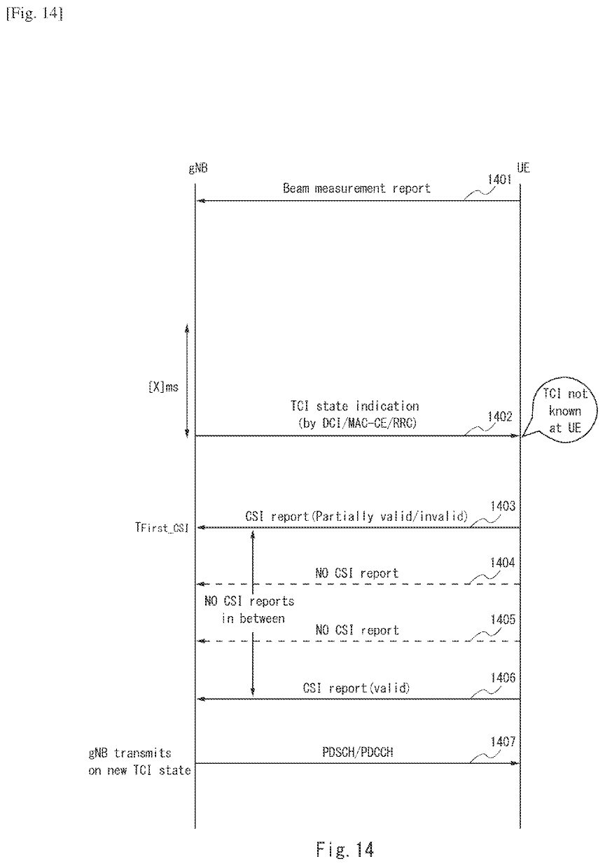

As shown in FIG. 14, in other alternate solution, gNB does not expect any CSI report till the time gNB receives valid CSI report 1406. Time till which gNB does not expect a CSI report(s) 1404-1405 can be configured. That is, if TCI state indication 1402 is sent after a time more than [X] ms from the report 1401 and if TCI state is not known to UE, between first instance of (partially valid/invalid) CSI report 1403 and till UE completes beam acquisition and sends valid CSI report 1406, UE shall not send any CSI reports 1404-1405. Upon reception of valid CSI report 1406, gNB transmits PDSCH/PDCCH 1407 on the new TCI state to UE.

As described above, upon reception of valid CSI report from UE, gNB transmits on new TCI state as per the adjusted TCI switch delay wherever applicable as shown in FIG. 12 and as per the initial TCI switch delay wherever applicable as shown in FIG. 13 and FIG. 14.

### Fifth Embodiment

In another embodiment (fifth embodiment) of the present disclosure, UE behaviour and gNB behaviour during TCI switching error cases is described. The UE and gNB behaviour is outlined below.

At 1501, RRC reconfiguration for beam management is initiated.

At 1502, beam measurement report by UE is provided.

At 1503, TCI state indication by gNB is provided.

At 1504, TCI switching is performed, which comprises of the following steps,

a. TCI state acquisition at UE, TCI state known status update at UE (if UE can acquire the beam, then beam is considered known; if UE cannot acquire the beam, then beam is considered unknown), CSI computation and evaluation

b. CSI report by UE based on the applicability
i. If beam report is sent less than [X] ms ago and if beam is not known at UE, UE shall send invalid or partially valid CSI report

c. gNB behaviour for the step b of present embodiment

d. TCI switch completion.

In detail, at 1501, gNB configures UE with measurement resources and measurement reporting resources. At 1502, based on the measurement resources and measurement reporting configuration UE measures and report beam measurements to gNB. At 1503, based on the beam measurement report, gNB may send a TCI state indication to UE if any stronger TCI state is found in beam report. At 1504, when UE receives TCI state indication through PDSCH (MAC CE or RRC) or PDCCH (DCI command), UE measures the CSI on the next available CSI resources which may be SSB/CSI-RS and perform,

a. UE may start procedure of beam acquisition, UE may update TCI state known status, measures the CSI and perform the CSI report evaluation.

b. Upon determining the type of CSI and CSI value to be reported, based on the beam report time.

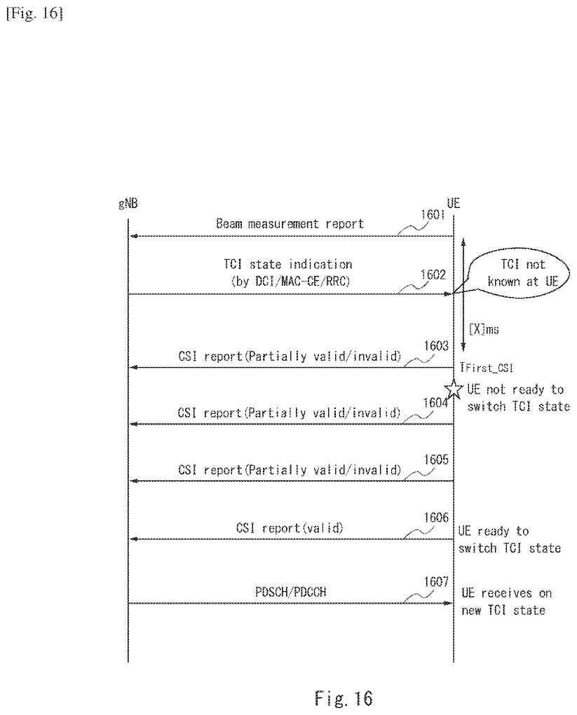

As shown in FIG. 16, if TCI state indication 1602 is sent within [X] ms from beam measurement report 1601 and if TCI state is not known to UE, UE should start performing the beam acquisition procedure. When CSI reporting resources are available, UE shall send partially valid or invalid CSI report(s) 1603-1605 on all CSI reporting instances till UE completes beam acquisition procedure. Upon TCI state acquisition completion, UE should send valid CSI report 1606. TCI switch delay should be adjusted to TCI switch delay (unknown) corresponding to unknown TCI state switch. In FIG. 16, UE prepares to switch TCI state and receives PDSCH/PDCCH 1607 on the new TCI state.

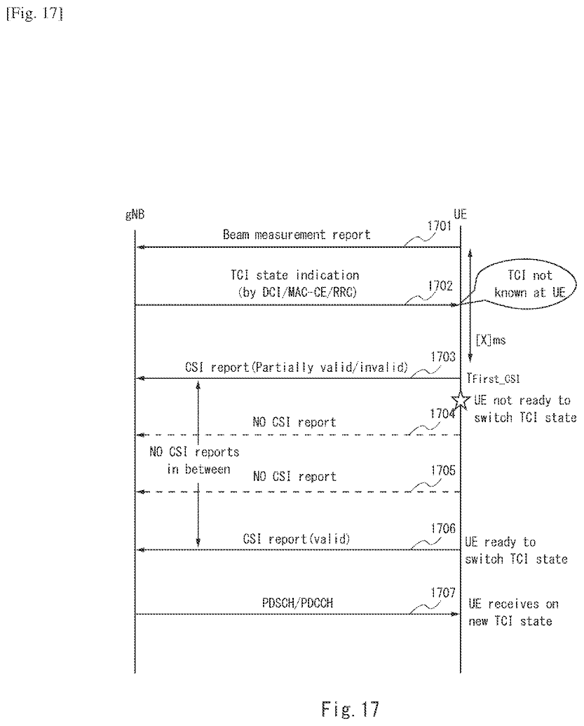

Alternate solution/behaviour for this problem is shown in FIG. 17. If TCI state indication 1702 is sent within [X] ms from beam measurement report 1701 and if TCI state is not known to UE, between first instance of (partially valid/invalid) CSI report 1703 and till UE completes beam acquisition (valid CSI report 1706), UE shall not send any CSI reports 1703-1705. That means even though gNB configures a UE with CSI reporting resources, since first CSI report is partially valid or invalid CSI report, subsequent CSI reports till the valid CSI report, will also be partially valid or invalid CSI reports, it means that gNB is not getting any useful information from UE. Hence it is beneficial to skip the CSI reports in between the partially valid/invalid CSI report to valid CSI report even when UE has CSI reporting resources configured. Time till which UE does not send CSI reports can be configured. In FIG. 17, UE prepares to switch TCI state and receives PDSCH/PDCCH 1707 on the new TCI state.

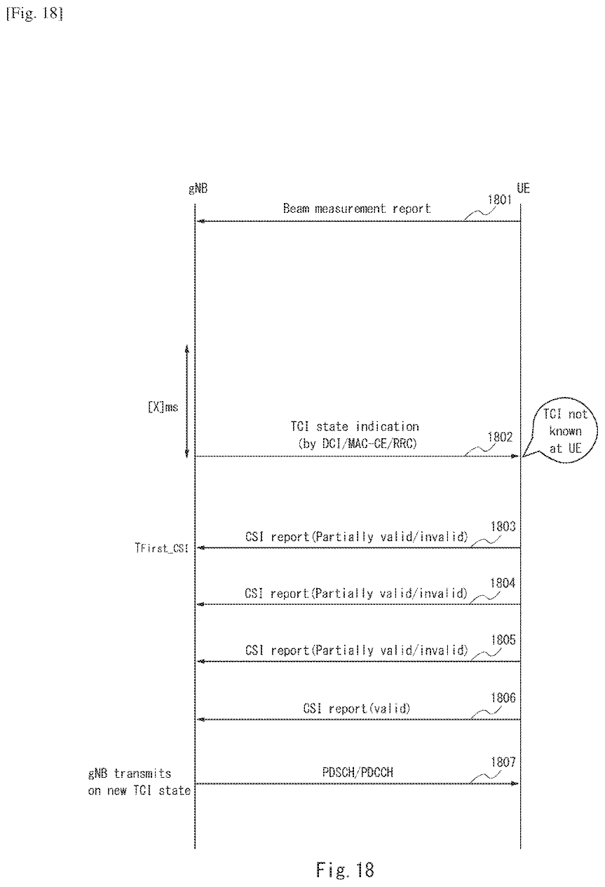

i. If TCI state of UE is known at gNB when gNB issues TCI state indication and gNB receives invalid or partially valid CSI report, gNB assumes that beam is no longer known at UE and waits for the valid CSI report to mark the completion of TCI state acquisition at UE. Till the valid CSI report 1806 is received, gNB expects UE to report invalid or partially valid CSI report(s) 1803-1805 as shown in FIG. 18. That is, if TCI state indication 1802 is sent after a time more than [X] ms from the report 1801 and if TCI state is not known to UE, UE shall send partially valid or invalid CSI report(s) 1803-1805 till UE sends valid CSI report 1806. Upon reception of valid CSI report 1806, gNB transmits PDSCH/PDCCH 1807 on the new TCI state to UE. TCI switch delay should be adjusted to TCI switch delay corresponding to unknown TCI state switch.

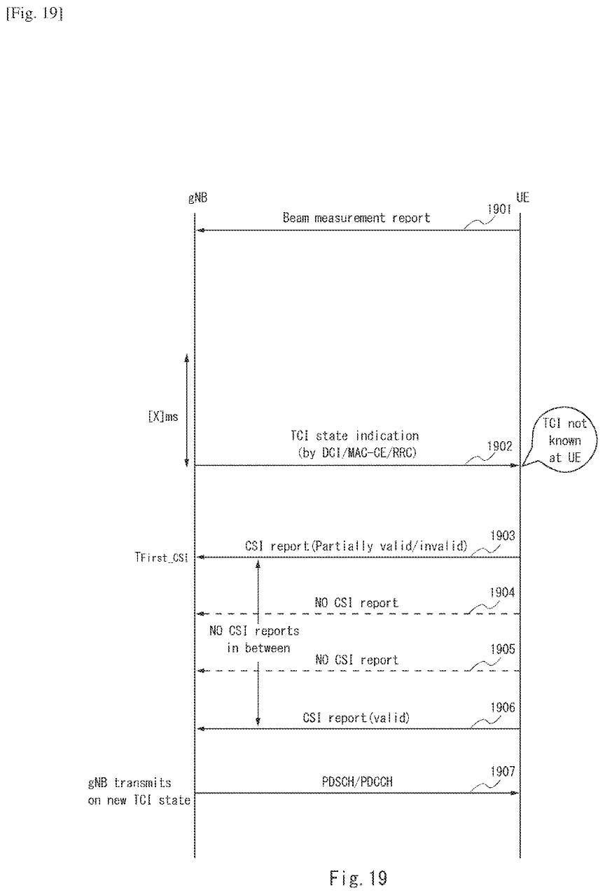

As shown in FIG. 19, in other alternate solution, gNB does not expect any CSI report from the first partially valid or invalid CSI report 1903 to the time gNB receives valid CSI report 1906. Time till which gNB does not expect a CSI report(s) 1904-1905 can be configured. That is, if TCI state indication 1902 is sent after a time more than [X] ms from the report 1901 and if TCI state is not known to UE, between first instance of (partially valid/invalid) CSI report 1903 and till UE completes beam acquisition and sends valid CSI report 1906, UE shall not send any CSI reports 1904-1905. When UE acquires TCI state, sends valid CSI report 1906 and switches TCI state. Upon reception of valid CSI report 1906, gNB transmits PDSCH/PDCCH 1907 on new TCI state.

### User Equipment (UE):

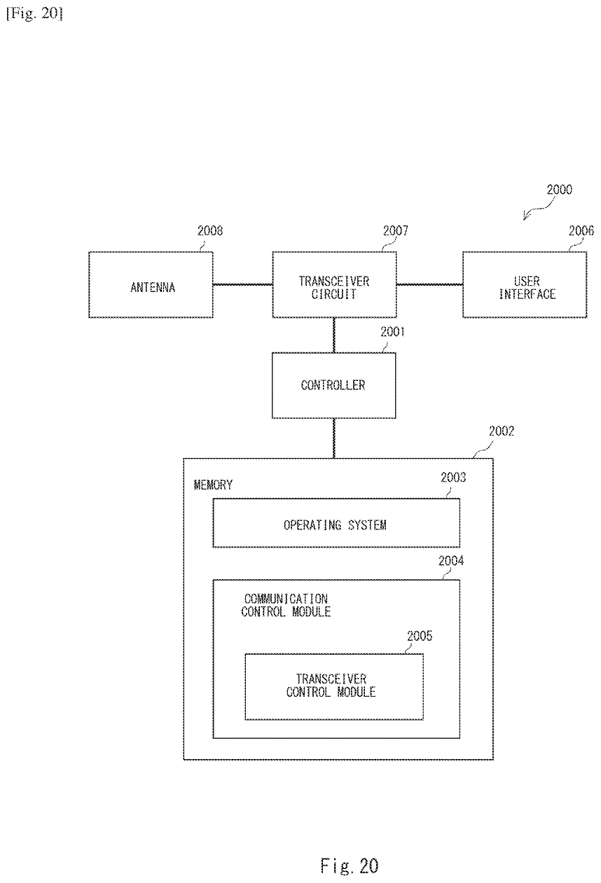

FIG. 20 is a block diagram illustrating the main components of the UE 2000. As shown, the UE 2000 includes a transceiver circuit 2007, which is operable to transmit signals to and to receive signals from the connected node(s) via one or more antenna 2008. Although not necessarily shown in FIG. 20, the UE 2000 will of course have all the usual functionality of a conventional mobile device (such as a user interface 2006) and this may be provided by any one or any combination of hardware, software and firmware, as appropriate. Software may be pre-installed in the memory 2002 and/or may be downloaded via the telecommunication network or from a removable data storage device (RMD), for example.

A controller 2001 controls the operation of the UE 2000 in accordance with software stored in a memory 2002. For example, the controller 2001 may be realized by Central Processing Unit (CPU). The software includes, among other things, an operating system 2003 and a communications control module 2004 having at least a transceiver control module 2005. The communications control module 2004 (using its transceiver control sub-module) is responsible for handling (generating/sending/receiving) signalling and uplink/downlink data packets between the UE 2000 and other nodes, such as the base station/(R)AN node, a MME, the AMF (and other core network nodes). Such signalling may include, for example, appropriately formatted signalling messages relating to connection establishment and maintenance (e.g. RRC messages,), NAS messages such as periodic location update related messages (e.g. tracking area update, paging area updates, location area update) etc.

### (R)AN Node:

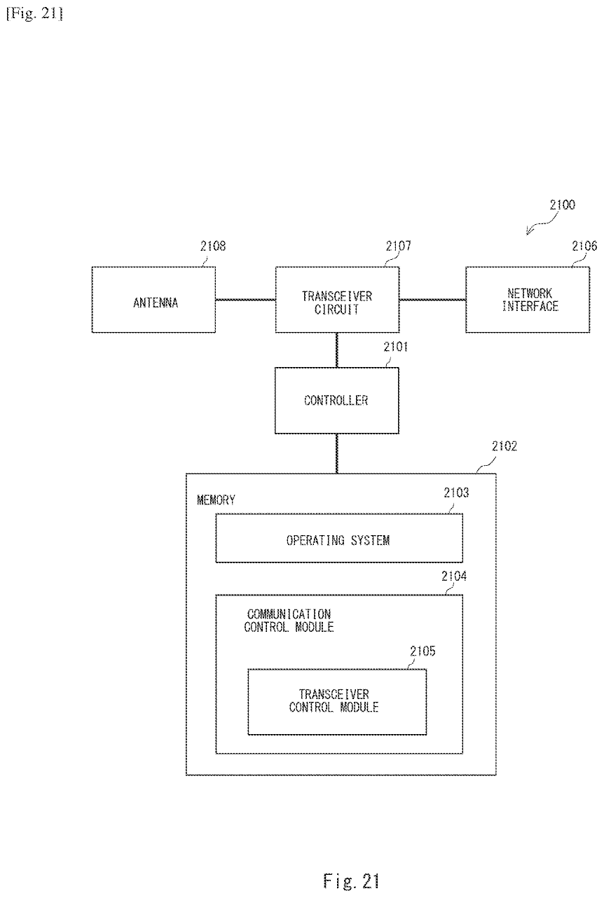

FIG. 21 is a block diagram illustrating the main components of an exemplary (R)AN node 2100, for example a base station (‘eNB’ in LTE, ‘gNB’ in 5G). As shown, the (R)AN node 2100 includes a transceiver circuit 2107 which is operable to transmit signals to and to receive signals from connected UE(s) via one or more antenna 2108, and to transmit signals to and to receive signals from other network nodes (either directly or indirectly) via a network interface 2106. A controller 2101 controls the operation of the (R)AN node 2100 in accordance with software stored in a memory 2102. For example, the controller 2101 may be realized by Central Processing Unit (CPU). Software may be pre-installed in the memory 2102 and/or may be downloaded via the telecommunication network or from a removable data storage device (RMD), for example. The software includes, among other things, an operating system 2103 and a communications control module 2104 having at least a transceiver control module 2105.

The communications control module 2104 (using its transceiver control sub-module) is responsible for handling (generating/sending/receiving) signalling between the (R)AN node 2100 and other nodes, such as the UE, the MME, the AMF (e.g. directly or indirectly). The signalling may include, for example, appropriately formatted signalling messages relating to a radio connection and location procedures (for a particular UE), and in particular, relating to connection establishment and maintenance (e.g. RRC connection establishment and other RRC messages), periodic location update related messages (e.g. tracking area update, paging area updates, location area update), S1 AP messages and NG AP messages (i.e. messages by N2 reference point), etc. Such signalling may also include, for example, broadcast information (e.g. Master Information and System information) in a sending case.

The controller 2101 is also configured (by software or hardware) to handle related tasks such as, when implemented, UE mobility estimate and/or moving trajectory estimation.

### Core Network Node:

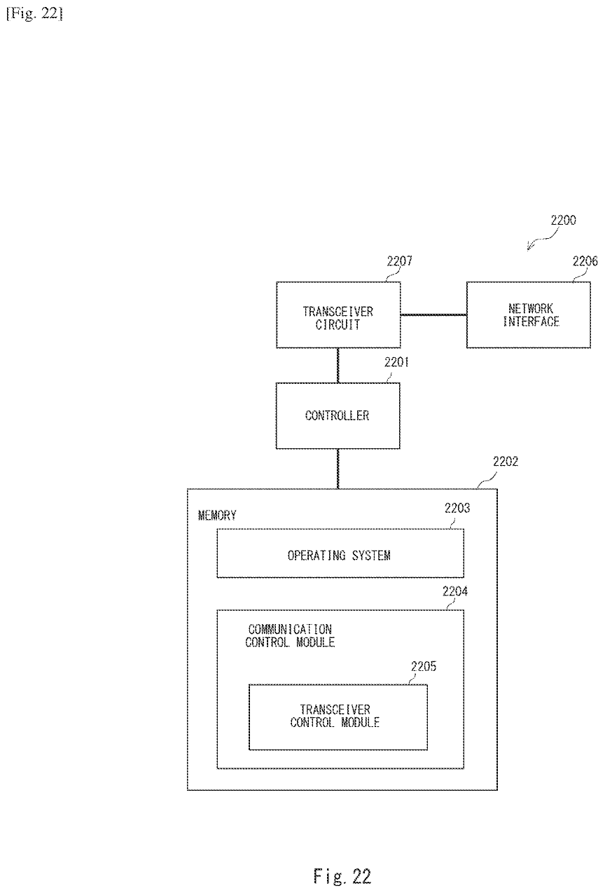

FIG. 22 is a block diagram illustrating the main components of an exemplary core network node 2200, for example an AMF, a SMF, a SEAF, an AUSF, an UPF, an UDM, an ARPF or any other core network node. The core network node 2200 is included in the 5GC. As shown, the core network node 2200 includes a transceiver circuit 2207 which is operable to transmit signals to and to receive signals from other nodes (including the UE) via a network interface 2206. A controller 2201 controls the operation of the core network node 2200 in accordance with software stored in a memory 2202. For example, the controller 2201 may be realized by Central Processing Unit (CPU). Software may be pre-installed in the memory 2202 and/or may be downloaded via the telecommunication network or from a removable data storage device (RMD), for example. The software includes, among other things, an operating system 2203 and a communications control module 2204 having at least a transceiver control module 2205.

The communications control module 2204 (using its transceiver control sub-module) is responsible for handling (generating/sending/receiving) signalling between the core network node 2200 and other nodes, such as the UE, base station/(R)AN node (e.g. “gNB” or “eNB”) (directly or indirectly). Such signalling may include, for example, appropriately formatted signalling messages relating to the procedures described herein, for example, NG AP message (i.e. a message by N2 reference point) to convey an NAS message from and to the UE, etc.

The User Equipment (or “UE”, “mobile station”, “mobile device” or “wireless device”) in the present disclosure is an entity connected to a network via a wireless interface. It should be noted that the UE in this specification is not limited to a dedicated communication device, and can be applied to any device, having a communication function as a UE described in this specification, as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery.

It will be appreciated that the terms “UE” and “wireless device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE may support one or more IoT or MTC applications. Some examples of MTC applications are listed in the following table (source: 3GPP TS 22.368 V13.1.0 (2014 December), Annex B, the contents of which are incorporated herein by reference). This list is not exhaustive and is intended to be indicative of some examples of machine-type communication applications.

TABLE
Some examples of machine-type communication applications.

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch eXchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and exemplary embodiments described in the present document. Needless to say, these technical ideas and embodiments are not limited to the above-described UE and various modifications can be made thereto.

As will be appreciated by one of skill in the art, the present disclosure may be embodied as a method, and system. Accordingly, the present disclosure may take the form of an entirely hardware aspect, a software aspect or an aspect combining software and hardware aspects.

It will be understood that each block of the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

This application is based upon and claims the benefit of priority from Indian patent applications No. 201911032978, filed on Aug. 14, 2019, the disclosure of which is incorporated herein in its entirety by reference.

The whole or part of the example embodiments disclosed above can be described as, but not limited to, the following supplementary notes.

(Supplementary Note 1)

A method of reporting channel state information, CSI, to a radio station by a user equipment, UE, comprising the steps of:

measuring at least one beam for a beam measurement report and a CSI report; sending the beam measurement report of the at least one beam to the radio station;

receiving, from the radio station, a transmission configuration indicator, TCI, state indication in response to the beam measurement report of the at least one beam; measuring at least one specific beam indicated by the TCI state indication to acquire the CSI of the at least one specific beam; wherein

sending a valid CSI report of the at least one specific beam, if the beam measurement report of the at least one specific beam was transmitted within a predetermined time; and sending a partially valid CSI report or an invalid CSI report of the at least one specific beam, if the beam measurement report of the at least one specific beam was transmitted more than a predetermined time ago.

(Supplementary Note 2)

The method described in Supplementary note 1, wherein:

the UE is allowed to send the valid CSI report, if the UE successfully acquire the CSI of the at least one specific beam regardless of a timing of the beam measurement report of the at least one specific beam.

(Supplementary Note 3)

The method described in Supplementary note 1 or 2, wherein:

the valid CSI report comprises defined value or values for successful CSI reporting wherein the UE successfully acquired the CSI, and

the partially valid CSI report or the invalid CSI report comprises a value outside the value or values defined for the successful CSI reporting.

(Supplementary Note 4)

The method described in any one of Supplementary notes 1 to 3, wherein:

the plurality of CSI reports are sent by UE, which are partially valid or invalid till it acquires and sends valid CSI report; or

the plurality of CSI reports skipped by the UE, from sending to radio station, in between the partially valid or invalid CSI report and valid CSI report.

(Supplementary Note 5)

The method described in any one of Supplementary notes 1 to 4, comprising:

measuring the CSI, by UE, on next available CSI resource for evaluation, during and upon acquisition of the specified beam.

(Supplementary Note 6)

The method described in any one of Supplementary notes 1 to 5, comprising: receiving PDSCH/PDCCH on a new TCI known state.

(Supplementary Note 7)

The method described in any one of Supplementary notes 1 to 6, comprising, categorizing the CSI report into partially valid or invalid CSI report, upon determination of an unknown beam at the UE.

(Supplementary Note 8)

The method described in any one of Supplementary notes 1 to 7, comprising reporting of partially valid CSI to the radio station.

(Supplementary Note 9)

The method described in any one of Supplementary notes 1 to 8, comprising reporting of invalid CSI to the radio station.

(Supplementary Note 10)

The method described in any one of Supplementary notes 1 to 9, comprising:

providing switching command to the UE upon determination of TCI state of the UE as known state.

(Supplementary Note 11)

The method described in any one of Supplementary notes 1 to 10, comprising:

providing switching command to the UE by configuring different TCI switching delay for the unknown TCI state of the UE at the radio station.

(Supplementary Note 12)

A communication system for reporting channel state information, CSI, comprising: a radio station;

a user equipment, UE, wherein:

the UE is configured to measure at least one beam for a beam measurement report and a CSI report, from the radio station; and

to send the beam measurement report of the at least one beam to the radio station; wherein

the radio station is configured to send a transmission configuration indicator, TCI, state indication, to the UE, in response to the beam measurement report of the at least one beam; wherein

the UE is configured to measure at least one specific beam indicated by the TCI state indication to acquire the CSI of the at least one specific beam; and

to send a valid CSI report of the at least one specific beam, if the beam measurement report was transmitted within a predetermined time; and

sending, a partially valid CSI report or an invalid CSI report of the at least one specific beam, if the beam measurement report was transmitted more than a predetermined time ago.

(Supplementary Note 13)

The communication system described in Supplementary note 12, wherein:

the UE is allowed to send the valid CSI report, if the UE successfully acquire the CSI of the at least one specific beam regardless of a timing of the beam measurement report of the at least one specific beam.

(Supplementary Note 14)

The communication system described in Supplementary note 12 or 13, wherein:

the valid CSI report comprises a value or values defined for successful CSI reporting in which the UE successfully acquire the CSI and

the partially valid CSI report or the invalid CSI report comprises a value outside the value or values defined for the successful CSI reporting.

(Supplementary Note 15)

The communication system described in any one of Supplementary notes 12 to 14, wherein:

the radio station is configured to receive the plurality of CSI reports for evaluation which comprises of partially valid or invalid CSI report till it receives valid CSI report; or

the radio station is configured to skip the plurality of CSI reports for evaluation in between the partially valid or invalid CSI report till it receives valid CSI report.

(Supplementary Note 16)

The communication system described in any one of Supplementary notes 12 to 15, wherein the radio station is configured to receive CSI report for the acquired beam from UE.

(Supplementary Note 17)

The communication system described in any one of Supplementary notes 12 to 16, wherein the radio station transmits PDSCH/PDCCH on a new TCI state.

(Supplementary Note 18)

The communication system described in any one of Supplementary notes 12 to 17, wherein the radio station is configured to categorize the CSI report into partially valid or invalid CSI report for the unknown beam.

(Supplementary Note 19)

The communication system described in any one of Supplementary notes 12 to 18, wherein the radio station is configured to receive partially valid CSI report.

(Supplementary Note 20)

The communication system described in any one of Supplementary notes 12 to 19, wherein the radio station is configured to receive invalid CSI report.

(Supplementary Note 21)

The communication system described in any one of Supplementary notes 12 to 20, wherein the radio station is configured to transmit switching command to the UE upon determination of the TCI state of the UE as known state.

(Supplementary Note 22)

The communication system described in any one of Supplementary notes 12 to 21, wherein the radio station is configured to transmit switching command to the UE by configuring different TCI switching delay for the unknown TCI state of the UE.

(Supplementary Note 23)

A method of scheduling TCI for a UE by a radio station, comprising the steps of:

registering the UE;

receiving at least one beam measurement report;

transmitting, a transmission configuration indicator state indication based on the received measurement report which consists of at least one beam;

receiving an updated TCI state known status implicitly using type of CSI report during and upon acquisition of said TCI state by the UE; wherein

receiving, a valid CSI report of the at least one specific beam, if the beam measurement report was received within a predetermined time; and

receiving, a partially valid CSI report or an invalid CSI report of the at least one specific beam, if the beam measurement report was received more than a predetermined time ago; and

adjusting the TCI switching delay based on the type of CSI report received.

(Supplementary Note 24)

The method described in Supplementary note 23, comprising:

receiving plurality of CSI reports from the UE for evaluation which comprises of partially valid or invalid CSI report till it receives valid CSI report; or

skipping the plurality of CSI reports from the UE for evaluation in between the partially valid or invalid CSI report and valid CSI report.

(Supplementary Note 25)

The method described in Supplementary note 23 or 24, comprising: transmitting PDSCH/PDCCH on a new TCI known state.

(Supplementary Note 26)

The method described in any one of Supplementary notes 23 to 25, comprising: receiving partially valid or invalid or valid CSI reports.

(Supplementary note 27)

The method described in any one of Supplementary notes 23 to 26, comprising:

determining UE TCI known state for transmitting switching command.

(Supplementary Note 28)

The method described in any one of Supplementary notes 23 to 27, comprising:

adjusting TCI state switch delay according to the updated TCI state known status implicitly acquired from the partially valid or invalid or valid CSI report type.

### REFERENCE SIGNS LIST

2000 UE
2001 controller
2002 memory
2003 operating system
2004 communication control module
2005 transceiver control module
2006 user interface
2007 transceiver circuit
2008 antenna
2100 (R)AN node
2101 controller
2102 memory
2103 operating system
2104 communication control module
2105 transceiver control module
2106 network interface
2107 transceiver circuit
2108 antenna
2200 core network node
2201 controller
2202 memory
2203 operating system
2204 communication control module
2205 transceiver control module
2206 network interface
2207 transceiver circuit

What is claimed is:

1. A method of reporting channel state information, CSI, to a radio station by a user equipment, UE, comprising:
measuring at least one beam for a beam measurement report and a CSI report; sending the beam measurement report of the at least one beam to the radio station;
receiving, from the radio station, a transmission configuration indicator, TCI, state indication in response to the beam measurement report of the at least one beam; measuring at least one specific beam indicated by the TCI state indication to acquire the CSI of the at least one specific beam; wherein
sending a valid CSI report of the at least one specific beam, if the beam measurement report of the at least one specific beam was transmitted within a predetermined time; and sending a partially valid CSI report or an invalid CSI report of the at least one specific beam, if the beam measurement report of the at least one specific beam was transmitted more than a predetermined time ago.

2. The method as claimed in claim 1, wherein:
the UE is allowed to send the valid CSI report, if the UE successfully acquire the CSI of the at least one specific beam regardless of a timing of the beam measurement report of the at least one specific beam.

3. The method as claimed in claim 1, wherein:
the valid CSI report comprises defined value or values for successful CSI reporting wherein the UE successfully acquired the CSI, and
the partially valid CSI report or the invalid CSI report comprises a value outside the value or values defined for the successful CSI reporting.

4. The method as claimed in claim 1, wherein:
the plurality of CSI reports are sent by UE, which are partially valid or invalid till it acquires and sends valid CSI report; or
the plurality of CSI reports skipped by the UE, from sending to radio station, in between the partially valid or invalid CSI report and valid CSI report.

5. The method as claimed in claim 1, comprising:
measuring the CSI, by UE, on next available CSI resource for evaluation, during and upon acquisition of the specified beam.

6. The method as claimed in claim 1, comprising:
receiving PDSCH/PDCCH on a new TCI known state.

7. The method as claimed in claim 1, comprising, categorizing the CSI report into partially valid or invalid CSI report, upon determination of an unknown beam at the UE.

8. The method as claimed in claim 1, comprising reporting of partially valid CSI to the radio station.

9. The method as claimed in claim 1, comprising reporting of invalid CSI to the radio station.

10. The method as claimed in claim 1, comprising:
providing switching command to the UE upon determination of TCI state of the UE as known state.

11. The method as claimed in claim 1, comprising:
providing switching command to the UE by configuring different TCI switching delay for the unknown TCI state of the UE at the radio station.

12. A communication system for reporting channel state information, CSI, comprising: a radio station;
a user equipment, UE, wherein:
the UE is configured to measure at least one beam for a beam measurement report and a CSI report, from the radio station; and
to send the beam measurement report of the at least one beam to the radio station; wherein
the radio station is configured to send a transmission configuration indicator, TCI, state indication, to the UE, in response to the beam measurement report of the at least one beam; wherein
the UE is configured to measure at least one specific beam indicated by the TCI state indication to acquire the CSI of the at least one specific beam; and
to send a valid CSI report of the at least one specific beam, if the beam measurement report was transmitted within a predetermined time; and
sending, a partially valid CSI report or an invalid CSI report of the at least one specific beam, if the beam measurement report was transmitted more than a predetermined time ago.

13. The communication system as claimed in claim 12, wherein:
the UE is allowed to send the valid CSI report, if the UE successfully acquire the CSI of the at least one specific beam regardless of a timing of the beam measurement report of the at least one specific beam.

14. The communication system as claimed in claim 12, wherein:
the valid CSI report comprises a value or values defined for successful CSI reporting in which the UE successfully acquire the CSI and
the partially valid CSI report or the invalid CSI report comprises a value outside the value or values defined for the successful CSI reporting.

15-22. (canceled)

23. A method of scheduling TCI for a UE by a radio station, comprising:
registering the UE;
receiving at least one beam measurement report;
transmitting, a transmission configuration indicator state indication based on the received measurement report which consists of at least one beam;
receiving an updated TCI state known status implicitly using type of CSI report during and upon acquisition of said TCI state by the UE; wherein
receiving, a valid CSI report of the at least one specific beam, if the beam measurement report was received within a predetermined time; and
receiving, a partially valid CSI report or an invalid CSI report of the at least one specific beam, if the beam measurement report was received more than a predetermined time ago; and
adjusting the TCI switching delay based on the type of CSI report received.

24. The method as claimed in claim 23, comprising:
receiving plurality of CSI reports from the UE for evaluation which comprises of partially valid or invalid CSI report till it receives valid CSI report; or
skipping the plurality of CSI reports from the UE for evaluation in between the partially valid or invalid CSI report and valid CSI report.

25. The method as claimed in claim 23, comprising: transmitting PDSCH/PDCCH on a new TCI known state.

26. The method as claimed in claim 23, comprising: receiving partially valid or invalid or valid CSI reports.

27. The method as claimed in claim 23, comprising:
determining UE TCI known state for transmitting switching command.

28. The method as claimed in claim 23, comprising:
adjusting TCI state switch delay according to the updated TCI state known status implicitly acquired from the partially valid or invalid or valid CSI report type.
